(19) United States
(12) Patent Application Publication
(10) Pub. No.: US 2020/0239235 A1
(43) Pub. Date: Jul. 30, 2020

(54) CHUTE FOR TRANSFERRING FLOWABLE PARTICULATE MATERIAL

(71) Applicant: CDE Global Limited, Cookstown (GB)

(72) Inventor: Anthony Convery, Moneymore (GB)

(21) Appl. No.: 16/776,701

(22) Filed: Jan. 30, 2020

(30) Foreign Application Priority Data
Jan. 30, 2019 (GB) 1901240.0

(51) Int. Cl. B65G 11/16; B65G 11/02; B65G 11/18

(52) U.S. Cl. CPC B65G 11/16; B65G 2207/48; B65G 11/18; B65G 11/02

(57) ABSTRACT

A chute includes at least one wall defining a conveying surface, and an abrasion resistant wear liner being attached the at least one wall to cover at least part of the conveying surface. The wall includes one or more apertures therein, which are covered by the abrasion resistant wear liner when attached to the at least one wall, whereby the one or more apertures expose at least a portion of the wear liner to an exterior of the chute.

### FIELD OF THE INVENTION

This invention relates to a chute for transferring flowable particulate material and in particular to a chute for transferring flowable particulate material having an abrasion resistant wear liner on the conveying surfaces of the chute.

### BACKGROUND OF THE INVENTION

Chutes are commonly used to transfer flowable particulate material, such as minerals, sand or aggregate, under gravity between stages of a material processing apparatus, for example between conveyors and screens or hoppers.

The conveying surfaces of such chutes undergo abrasion due to the hard or chemically aggressive material being transported thereon. Therefore chutes are commonly provided with a sacrificial abrasion resistant wear liner, comprising plates, tiles or sheets of an abrasion resistant material, on their conveying surfaces that can be periodically replaced when worn out.

However, the only way to inspect the condition of such a wear liner is to shut down the apparatus and visually inspect the wear liner for excessive damage. This process is made more difficult by the location of the wear liner on the inner faces of a chute having restricted space and to which accessibility may be limited. Therefore excessive wear of the wear liner may go unnoticed until the wear liner becomes perforated, subsequently leading to damage to the walls of the chute itself. This may then require damaged sections of the chute walls to be cut out and new sections to be welded in in a time consuming and labour intensive operation.

### SUMMARY OF THE INVENTION

According to one form of the present invention there is provided a chute comprising at least one wall defining a conveying surface, an abrasion resistant wear liner being attached the at least one wall to cover at least part of the conveying surface, wherein the wall includes one or more apertures therein covered by the abrasion resistant wear liner when attached to the at least one wall, whereby the one or more apertures expose at least a portion of the wear liner to an exterior of the chute.

The one or more apertures may have an area of at least 50% of the surface area of the abrasion resistant wear liner.

In one embodiment the wear liner may comprise one or more plates, tiles or sheets of an abrasion resistant material releasably attached to the wall.

The wear liner may comprise a plurality of contiguous sections, at least a respective one of the one or more apertures being aligned with each section of the wear liner such that at least a portion of each of the sections of the wear liner is exposed to an exterior of the chute via the respective apertures. The at least one wall may comprise a peripheral border region and a plurality of interconnected elongate webs and/or reinforcing members, the apertures being defined between the peripheral border region and/or between the plurality of interconnected elongate webs and/or reinforcing members.

Optionally, the wear liner may be coupled to the at least one wall by releasable fasteners, such as threaded fasteners (e.g. nuts and bolts).

The chute may be defined by a plurality of walls defining a duct having an inlet and an upper end, wherein the conveying surface is defined by inner faces of the duct. The plurality of walls may comprise a front wall, a rear wall and first and second side walls linking the front and rear walls. The front, rear and side walls of the chute may be coupled to one another by releasable fasteners, such as threaded fasteners (e.g. nuts and bolts).

These and other objects, advantages, purposes and features of the present invention will become apparent upon review of the following specification in conjunction with the drawings.

### BRIEF DESCRIPTION OF THE DRAWINGS

A chute in accordance with an embodiment of the present invention will now be described, by way of example only, with reference to the accompanying drawings, in which:—

FIG. 1 is a front view of a chute in accordance with an embodiment of the present invention;

FIG. 2 is a rear view of the chute of FIG. 1;

FIGS. 3 and 4 are respective side views of the chute of FIG. 1;

FIG. 5 is a perspective view of the chute of FIG. 1; and

FIG. 6 is a partially exploded view of the chute of FIG. 1.

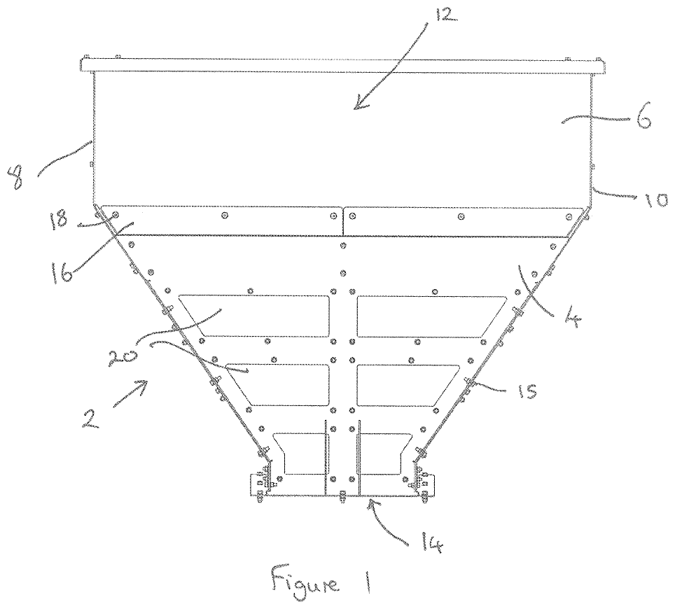

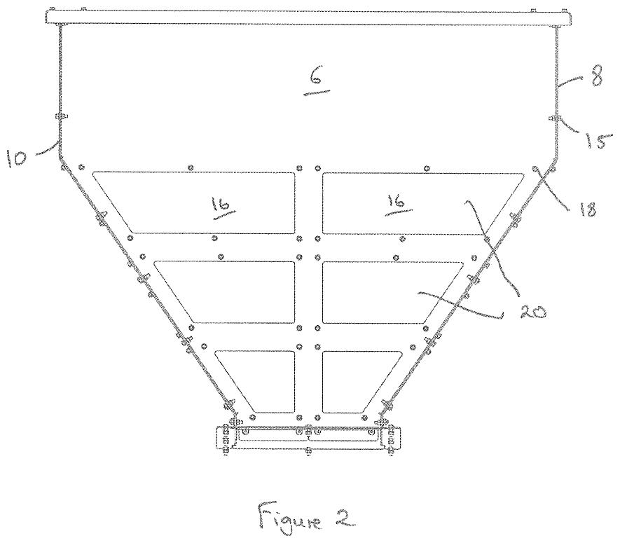

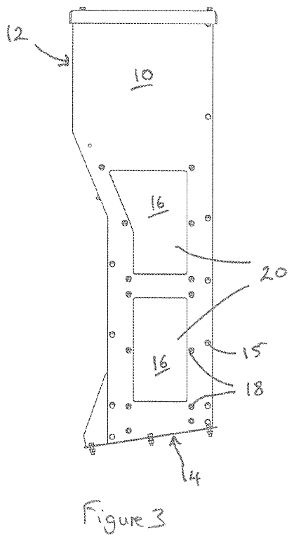

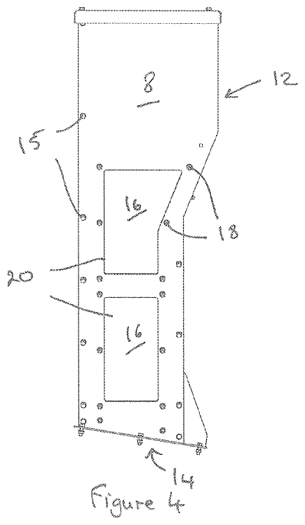

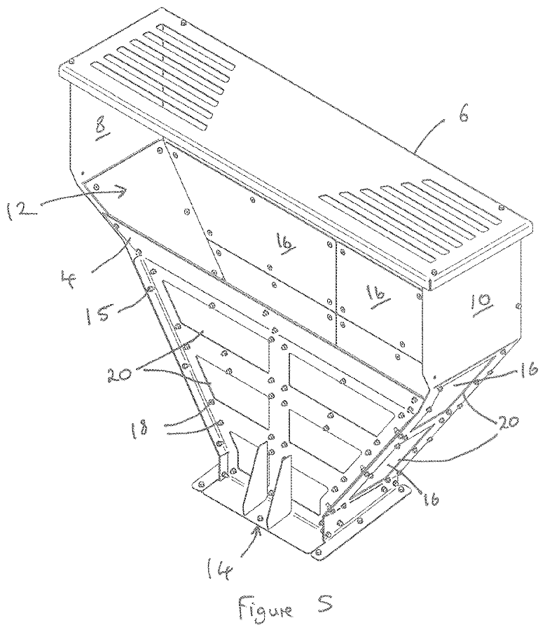

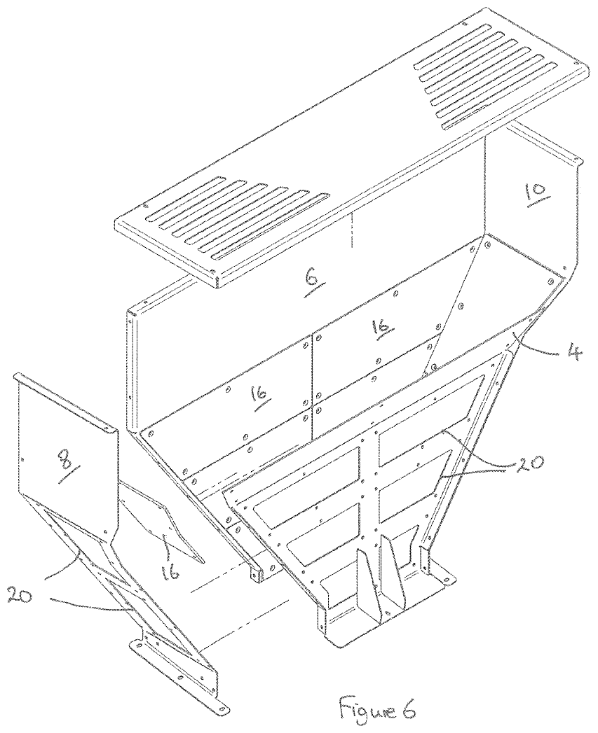

### DETAILED DESCRIPTION OF THE DRAWINGS

As illustrated in the drawings, a chute for transferring flowable particulate material in accordance with an embodiment of the present invention comprises a front wall 4, a rear wall 6 and first and second side walls 8,10 linking the front and rear walls 4,6 to define an enclosed duct having an inlet 12 at an upper end and an outlet 14 at a lower end. The walls 4,6,8,10 of the chute 2 may be formed from sheet steel, such as by means of a stamping or pressing procedure.

The front, rear and side walls 4,6,8,10 of the chute 2 may be joined together by means of releasable fasteners, such as nuts and bolts 15, inserted through aligned apertures in cooperating mounting flanges formed on the walls, thus avoiding the need for welding.

An abrasion resistant wear liner is provided on the conveying surfaces of the chute to define at least part of the conveying surface of the chute. The wear liner is defined by a plurality of contiguous wear plates 16 which are preferably affixed to inner faces of the front, rear and side walls 4,6,8,10 to define abrasion resistant conveying surfaces of the chute 2. The wear plates 16 of the wear liner are preferably attached to the walls 4,6,8,10 of the chute 2 by means of releasable fasteners, such as nuts and bolts 18, avoiding the need for welding and allowing the wear plates 16 to be readily detached for replacement.

Each of the front, rear and side walls 4,6,8,10 of the chute 2 includes a plurality of apertures 20 formed therein arranged to be covered by the wear plates 16 of the wear liner when attached to the walls of the chute, whereby the apertures 16 expose at least a portion of each wear plate 16 of the wear liner to the exterior of the chute 2. In the illustrated embodiment, the apertures 20 are dimensioned to match the size of each wear plate 16 while leaving sufficient surrounding wall material to permit secure attachment of each wear plate 16 to the walls 4,6,8,10 of the chute 2 and to provide sufficient support for the wear plates 16 by the walls 4,6,8,10 of the chute 2.

Each wear plate 16 may be formed from a wear resistant material, or may be provided with a wear resistant material on one face thereof. The abrasion resistant material may comprise a polymeric material such as rubber, a ceramic material or a metal.

In one embodiment each wear plate 16 may comprise a metal plate, such as a steel plate, having a wear resistant material, such as a ceramic or polymeric material, provided on (for example bonded to) at least one face thereof, the at least one face defining a part of the conveying surfaces of the chute 2 when the wear plates 16 are attached to the walls 4,6,8,10 of the chute 2.

By exposing at least a portion of each wear plate 16 of the wear liner on an outer side of the chute 2 via the apertures 20 in the walls 4,6,8,10 of the chute 2, perforation of any wear plates 16 due to abrasion will be readily identifiable by means of a visual inspection of the exterior of the chute without needing access to the inside of the chute and without decommissioning the apparatus. The bolted assembly of the wear plates 16 and walls 4,6,8,10 of the chute 2 will facilitate replacement of worn wear plates 16.

Furthermore, any such perforation of the wear plates 16 will generally not lead to subsequent deterioration or damage of the walls 4,6,8,10 of the chute 2.

The provision of apertures 20 in the walls 4,6,8,10 will also serve to reduce the overall weight of the chute 2.

The invention is not limited to the embodiment described herein but can be amended or modified without departing from the scope of the present invention, which is intended to be limited only by the scope of the appended claims as interpreted according to the principles of patent law including the doctrine of equivalents.

1. A chute comprising:
at least one wall defining a conveying surface; and
an abrasion resistant wear liner being attached to said at least one wall to cover at least part of said conveying surface;
wherein said wall includes one or more apertures therein, said one or more apertures covered by said abrasion resistant wear liner when said wear liner is attached to said at least one wall, whereby said one or more apertures expose at least a portion of said wear liner to an exterior of said chute.

2. The chute of claim 1, wherein said one or more apertures have an area of at least 50% of the surface area of said abrasion resistant wear liner.

3. The chute of claim 1, wherein said wear liner comprises one or more plates, tiles or sheets of an abrasion resistant material releasably attached to said wall.

4. The chute of claim 1, wherein said wear liner comprises a plurality of contiguous sections, at least a respective one of said one or more apertures being aligned with each section of said wear liner such that at least a portion of each of said sections of said wear liner is exposed to an exterior of said chute via said respective apertures.

5. The chute of claim 4, wherein said at least one wall comprises a peripheral border region and a plurality of interconnected elongate webs and/or reinforcing members, said apertures being defined between said peripheral border region and/or between said plurality of interconnected elongate webs and/or reinforcing members.

6. The chute of claim 1, wherein said wear liner is coupled to said at least one wall by releasable fasteners.

7. The chute of claim 6, wherein said releasable fasteners comprise threaded fasteners.

8. The chute of claim 1, wherein said chute comprises a plurality of walls defining a duct having an inlet and an upper end, wherein said conveying surface is defined by inner faces of said duct.

9. The chute of claim 8, wherein said plurality of walls comprise a front wall, a rear wall and first and second side walls linking said front and rear walls.

10. The chute of claim 9, wherein said front, rear and side walls are coupled to one another by releasable fasteners.

11. The chute of claim 10, wherein said releasable fasteners comprises threaded fasteners.
